(19) United States
(12) Patent Application Publication
(10) Pub. No.: US 2021/0019253 A1
(43) Pub. Date: Jan. 21, 2021

(54) Methods Circuits Devices Systems and Functionally Associated Machine Executable Code For Enhanced Automated Software Code Testing

(71) Applicants: Wael Abu Taha, Nof HaGalil (IL); Firas Matar, Nof HaGalil (IL); Ran Finkelstein, Tzur Yitzhak (IL); Ameer Abu Zhaya, Nof HaGalil (IL); Deeb Andrawis, Tur'an (IL)

(72) Inventors: Wael Abu Taha, Nof HaGalil (IL); Firas Matar, Nof HaGalil (IL); Ran Finkelstein, Tzur Yitzhak (IL); Ameer Abu Zhaya, Nof HaGalil (IL); Deeb Andrawis, Tur'an (IL)

(21) Appl. No.: 16/947,025

(22) Filed: Jul. 15, 2020

Related U.S. Application Data
(60) Provisional application No. 62/874,020, filed on Jul. 15, 2019.

(51) Int. Cl. G06F 11/36

(52) U.S. Cl. CPC G06F 11/3696; G06F 11/3688

(57) ABSTRACT

Disclosed are methods, circuits, devices, systems and functionally associated machine executable code for enhanced automated software code testing. A system for enhanced automated software code testing comprises a processing module for wrapping test script commands, of a software testing framework, with additional command execution monitoring or control code. The command execution monitoring or control code, is configured to collect and report test script execution parameters, resulting from test script execution. A test execution monitoring module for guiding the execution of the test script commands based on the test script execution parameters reported by the command execution monitoring or control code.

### RELATED APPLICATIONS SECTION

The present application claims priority from U.S. Provisional Patent Application No. 62/874,020, filed Jul. 15, 2019, which application is hereby incorporated by reference in its entirety.

### FIELD OF THE INVENTION

The present invention generally relates to the field of automated software code testing. More specifically, the present invention relates to methods, circuits, devices, systems and functionally associated machine executable code for enhanced automated software code testing.

### BACKGROUND

Software testing is an investigation conducted to provide stakeholders with information about the quality of the software product or service under test. Software testing can also provide an objective, independent view of the software to allow the business to appreciate and understand the risks of software implementation. Test techniques include the process of executing a program or application with the intent of finding software bugs (errors or other defects), and verifying that the software product is fit for use.

Software testing involves the execution of a software component or system component to evaluate one or more properties of interest. In general, these properties indicate the extent to which the component or system under test: meets the requirements that guided its design and development, responds correctly to all kinds of inputs, performs its functions within an acceptable time, is sufficiently usable, can be installed and run in its intended environments, and/or achieves the general result its stakeholders desire.

As the number of possible tests for even simple software components is practically infinite, all software testing uses some strategy to select tests that are feasible for the available time and resources. As a result, software testing typically (but not exclusively) attempts to execute a program or application with the intent of finding software bugs (errors or other defects). The job of testing is an iterative process as when one bug is fixed, it can illuminate other, deeper bugs, or can even create new ones.

Software testing can provide objective, independent information about the quality of software and risk of its failure to users or sponsors.

Software testing can be conducted as soon as executable software (even if partially complete) exists. The overall approach to software development often determines when and how testing is conducted. For example, in a phased process, most testing occurs after system requirements have been defined and then implemented in testable programs. In contrast, under an agile approach, requirements, programming, and testing are often done concurrently.

A common practice nowadays, is the use of portable frameworks, Selenium for example, for testing web applications. Testing frameworks, such as Selenium, often provide a playback tool for authoring functional tests without the need to learn a test scripting language. They may also provide a test domain-specific language to write tests in a number of popular programming languages, including for example: C#, Groovy, Java, Perl, PHP, Python, Ruby and Scala. The tests can then run against most modern web browsers. Such testing frameworks may be deployed on various operating systems, Selenium open-source software for example, deploys on Windows, Linux, and macOS platforms.

Still, popular open source test automation tools suffer from multiple pain points. There remains a need, in the field of automated software testing, for testing optimization and facilitation solutions for minimizing flaky tests, performing deeper test analysis, generating and providing higher level test reports, and shortening test runs—while enabling coding over familiar languages/platforms such as Selenium.

### SUMMARY OF THE INVENTION

Embodiments of the present invention include methods, circuits, devices, systems and functionally associated machine executable code for enhanced automated software code testing. According to certain embodiments of the present invention, raw commands from a test script of a software testing framework are examined and preprocessed, by a preprocessing module, before submission for execution within the testing framework. Preprocessing of a command may include reconfiguration of one or more command parameters, wrapping the original script command within additional execution monitoring and/or control code. Preprocessing of a command may also include queuing and/or ordering the command relative to other commands within the test script. Preprocessing of a command may also include queuing and/or ordering the command relative to detection of events occurring responsive the execution of the test script. Processing of application test script may be performed automatically through a test script ingestion and processing module. Test script command handling according to some events may be performed by a command handling module which may read and handle the test script in accordance with instructions and parameters added by the preprocessing module.

According to further embodiments, command wrapping may include the addition or insertion of test execution monitoring code/functionality. Monitoring code may be configured to sense, measure and report test script execution parameters, resulting from test script execution, such as for example: (1) appearance/creation of screen objects/elements; (2) exception notifications; (3) computing resource (e.g. CPU load, memory usage, storage access rates and/or networking access rates) usage and/or load; and/or (4) API behavior. According to embodiments, monitoring code may, responsive to monitoring test code execution, report results of said monitoring back to a test execution monitoring module. The test execution monitoring module according to embodiments may receive, aggregate, organize, filter and present for review (e.g. through a rendered dashboard) monitoring data provided by one or more segments of monitoring code.

According to further embodiments, preprocessing is done according to best practices rules. Execution of test script may be guided by the test execution monitoring module, monitoring output and execution rules. Test script execution guiding, in accordance with monitored output and execution rules, may include waiting for a set of one or more required preconditions to be fulfilled, prior to executing the command. Test script execution guiding may also include detection of command execution exceptions, wherein the execution of a command, for which one or more execution exceptions were detected, may be automatically retried. Test script execution guiding may also include verifying successful, and optionally complete, execution of a command, wherein the unsuccessful and/or incomplete execution of a command, for which no execution exceptions were detected, may be automatically retried.

Exceptions in the execution, and/or an unsuccessful verification, of an executed command, may automatically trigger its re-execution. Test script execution guiding, in accordance with some embodiments, may limit the number of retried executions of a given command, wherein upon reaching a threshold number of unsuccessful retried executions—a feedback request, an execution failure notice and/or a suggested test script change may be generated.

### BRIEF DESCRIPTION OF THE DRAWINGS AND APPENDIXES

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings:

FIG. 1, is a high level block diagram of an exemplary system for enhanced automated software code testing, in accordance with some embodiments of the present invention;

FIG. 2, is a block diagram of an exemplary system for enhanced automated software code testing, in accordance with some embodiments of the present invention, wherein system modules and interrelations there between are shown in further details;

FIG. 3, is a flowchart showing the main steps executed as part of an exemplary process for performing a test framework (Selenium) ‘Click’, wherein the test is monitored by added or inserted test execution monitoring code/functionality, in accordance with some embodiments of the present invention;

FIG. 4, is a flowchart showing the main steps executed as part of an exemplary process for performing a test framework (Selenium) ‘Driver findElement’, wherein the test is monitored by added or inserted test execution monitoring code/functionality, in accordance with some embodiments of the present invention;

FIGS. 5A-5B, shown test framework commands wrapping examples, and a demo of an exemplary wrapped commands test execution, along with reporting interface/dashboard screenshots associated therewith, in accordance with some embodiments of the present invention; and

FIGS. 6A-6E, shown screenshots associated with the main steps of an exemplary execution scenario of a test automation enhancement system implementing test-command monitoring-code insertion/wrapping, in accordance with some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals or element labeling may be repeated among the figures to indicate corresponding or analogous elements.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Unless specifically stated otherwise, as apparent from the following discussions, it is appreciated that throughout the specification discussions utilizing terms such as “processing”, “computing”, “calculating”, “determining”, or the like, may refer to the action and/or processes of a computer, computing system, computerized mobile device, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In addition, throughout the specification discussions utilizing terms such as “storing”, “hosting”, “caching”, “saving”, or the like, may refer to the action and/or processes of ‘writing’ and ‘keeping’ digital information on a computer or computing system, or similar electronic computing device, and may be interchangeably used. The term “plurality” may be used throughout the specification to describe two or more components, devices, elements, parameters and the like.

Some embodiments of the invention, for example, may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments of the invention may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device, for example a computerized device running a web-browser.

In some embodiments, the medium may be an electronic, magnetic, optical, electromagnetic, infrared, or semiconductor system (or apparatus or device) or a propagation medium. Some demonstrative examples of a computer-readable medium may include a semiconductor or solid state memory, magnetic tape, a removable computer diskette, a random access memory (RAM), a read-only memory (ROM), a rigid magnetic disk, and an optical disk. Some demonstrative examples of optical disks include compact disk—read only memory (CD-ROM), compact disk—read/write (CD-R/W), and DVD.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution. The memory elements may, for example, at least partially include memory/registration elements on the user device itself.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Functions, operations, components and/or features described herein with reference to one or more embodiments, may be combined with, or may be utilized in combination with, one or more other functions, operations, components and/or features described herein with reference to one or more other embodiments.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “includes”, “including”, “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

The present disclosure is to be considered as an exemplification of the invention, and is not intended to limit the invention to the specific embodiments illustrated by the figures or description below.

Embodiments of the present invention include methods, circuits, devices, systems and functionally associated machine executable code for enhanced automated software code testing. According to certain embodiments of the present invention, raw commands from a test script of a software testing framework are examined and preprocessed, by a preprocessing module, before submission for execution within the testing framework. Preprocessing of a command may include reconfiguration of one or more command parameters, wrapping the original script command within additional execution monitoring and/or control code. Preprocessing of a command may also include queuing and/or ordering the command relative to other commands within the test script. Preprocessing of a command may also include queuing and/or ordering the command relative to detection of events occurring responsive the execution of the test script. Processing of application test script may be performed automatically through a test script ingestion and processing module. Test script command handling according to some events may be performed by a command handling module which may read and handle the test script in accordance with instructions and parameters added by the preprocessing module.

According to further embodiments, command wrapping may include the addition or insertion of test execution monitoring code/functionality. Monitoring code may be configured to sense, measure and report test script execution parameters, resulting from test script execution, such as for example: (1) appearance/creation of screen objects/elements; (2) exception notifications; (3) computing resource (e.g. CPU load, memory usage, storage access rates and/or networking access rates) usage and/or load; and/or (4) API behavior. According to embodiments, monitoring code may, responsive to monitoring test code execution, report results of said monitoring back to a test execution monitoring module. The test execution monitoring module according to embodiments may receive, aggregate, organize, filter and present for review (e.g. through a rendered dashboard) monitoring data provided by one or more segments of monitoring code.

According to further embodiments, preprocessing is done according to best practices rules. Execution of test script may be guided by the test execution monitoring module, monitoring output and execution rules. Test script execution guiding, in accordance with monitored output and execution rules, may include waiting for a set of one or more required preconditions to be fulfilled, prior to executing the command. Test script execution guiding may also include detection of command execution exceptions, wherein the execution of a command, for which one or more execution exceptions were detected, may be automatically retried. Test script execution guiding may also include verifying successful, and optionally complete, execution of a command, wherein the unsuccessful and/or incomplete execution of a command, for which no execution exceptions were detected, may be automatically retried.

Exceptions in the execution, and/or an unsuccessful verification, of an executed command, may automatically trigger its re-execution. Test script execution guiding, in accordance with some embodiments, may limit the number of retried executions of a given command, wherein upon reaching a threshold number of unsuccessful retried executions—a feedback request, an execution failure notice and/or a suggested test script change may be generated.

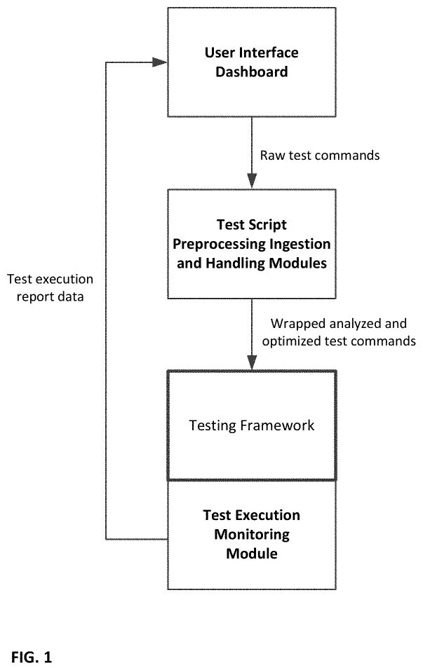

Reference is now made to FIG. 1, where there is shown a block diagram of an exemplary system for enhanced automated software code testing, in accordance with some embodiments of the present invention.

In the figure, raw test commands are shown to be relayed/uploaded from a user device, by the system's user interface dashboard. The system's test script processing modules, preprocesses the commands, wraps the commands with monitoring/control code, ques the wrapped commands and relays them for execution in the test framework.

The shown test execution monitoring module, guides the execution and processes feedback data provided by the monitoring code. Based on the processed feedback data, test execution report data is generated and communicated to the user interface dashboard for presentation.

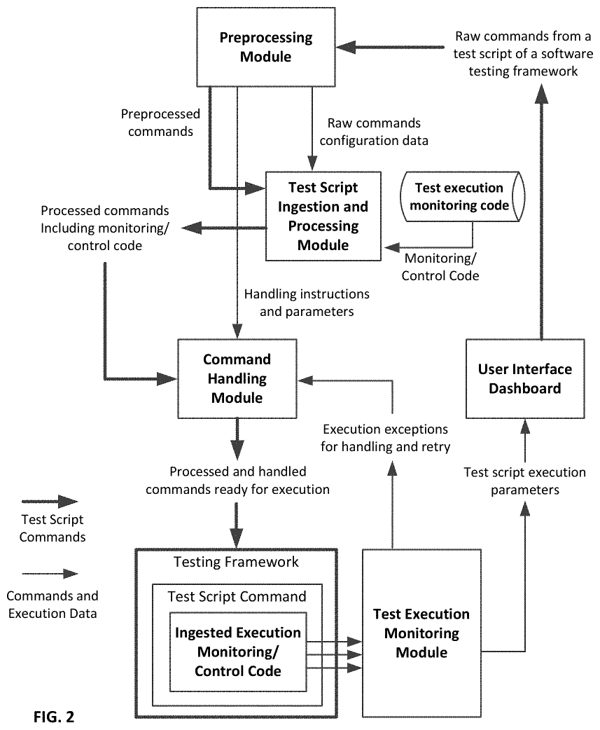

Reference is now made to FIG. 2, where there is shown a block diagram of an exemplary system for enhanced automated software code testing, in accordance with some embodiments of the present invention, wherein system modules and interrelations there between are shown in further details.

Raw commands from a test script of a software testing framework are examined and preprocessed, by a preprocessing module, before submission for execution within the testing framework. Preprocessing of the commands may include: (1) reconfiguration of one or more command parameters, wrapping the original script command within additional execution monitoring and/or control code; (2) queuing and/or ordering the command relative to other commands within the test script; and/or (3) queuing and/or ordering the command relative to detection of events occurring responsive the execution of the test script.

Processing of application test script is performed automatically through the shown test script ingestion and processing module using the stored/dynamically-generated monitoring/control code segments, for ingestion into the test script based on the received raw commands configuration data/instructions.

Test script command handling is performed by the shown command handling module that reads and handles the test script in accordance with instructions and parameters added and relayed by the preprocessing module. Handled commands are queued and relayed, by the command handling module, for test framework execution.

The execution monitoring/control code ingested into the test script commands senses, measures and reports test script execution parameters, resulting from execution of the enhanced/processed test script. The monitoring code, responsive to monitoring test code execution, reports the monitoring results back to the shown test execution monitoring module.

The test execution monitoring module receives, aggregates, organizes, filters and, relays for presentation and review—through the shown user interface dashboard rendered on a user device—monitoring data provided by, and/or generated based on, one or more segments of the executed monitoring/control code.

The execution of the test scripts is guided by the test execution monitoring module, monitoring execution outputs and execution rules. The test execution monitoring module guides the test script execution, in accordance with monitored output and execution rules. Execution exceptions and notifications, such as: (1) fulfillments of required preconditions for executing a command(s); (2) detections of command execution exceptions and the command execution retrying instructions; (3) verifications of successful, and optionally complete, execution of a command; (4) retrying instructions for unsuccessful and/or incomplete execution of a command, for which no execution exceptions were detected; and/or (5) parameters indicating the number of retried executions for specific test script commands—are relayed to: the user interface dashboard for user presentation and review; and/or, to the command handling module for queueing for retried, differed and/or repaired/changed-script execution.

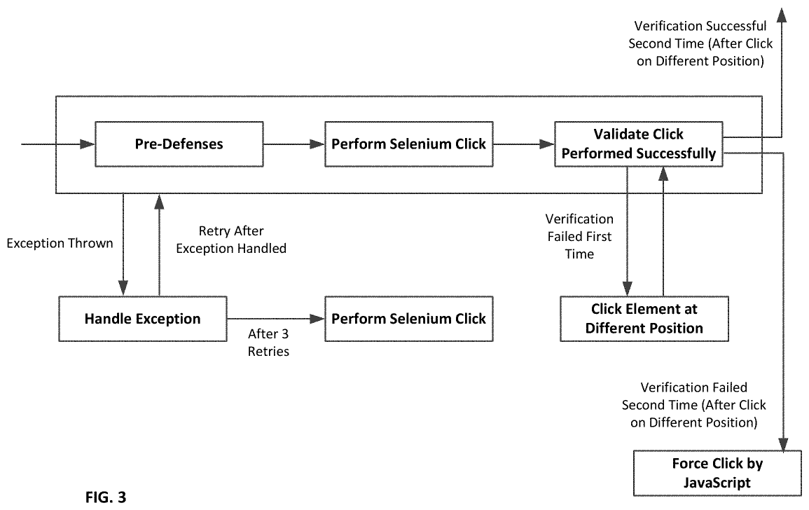

Reference is now made to FIG. 3, where there is shown a flowchart of the main steps executed as part of an exemplary process for performing a test framework (Selenium) ‘Click’, wherein the test is monitored by added or inserted test execution monitoring/control code/functionality, in accordance with some embodiments of the present invention.

Shown process steps include:

(1) Pre-Defense steps, for example: (a) waiting for element visibility; (b) putting element in view port; and/or (c) waiting for element to be enabled.

(2) Validation steps, taken after the selenium Click was performed, for example: (a) if element tag is input and no type is specified or the type is “text” then check if the element is on focus (JavaScript), otherwise the click is valid; and/or, if verification failed, then (b) click element on different position, for example, according to the browser type (Chrome—click at center of element, Firefox—click at the left upper corner of the element).

If the verification is failed another (e.g. second, third . . . ) time, for example after clicking on a different position, then the Click is forced by JavaScript. If the verification is successful, on the first time or after clicking on a different position, associated data is relayed for user reporting/notifying and/or saved for future—executions history related—reference.

(3) Exceptions Handling steps, taken in response to execution exceptions thrown, for example: (a) in response to a Timeout exception (e.g. in waiting for condition at the pre-defenses section)—increasing timeout; (b) in response to a Stale Element exception or No Such Element exception—reallocating element; (c) in response to an Element Not Visible or Element Not Interactable exceptions—putting/positioning element in view port again; and/or (d) in response to an Element Not Clickable At Point exception—clicking on different position according to browser type.

Thrown exceptions are handled and returned for retrying command execution. Upon a successful retry, or threshold number (e.g. 3) of failed retry/retries, the selenium Click is performed.

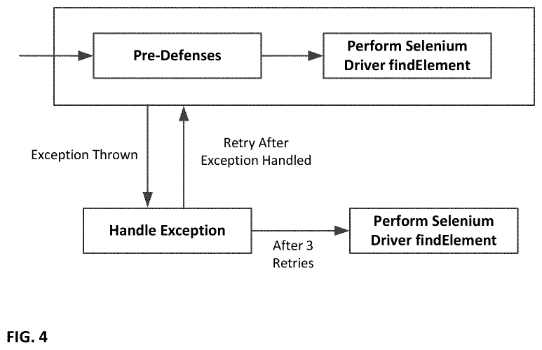

Reference is now made to FIG. 4, where there is shown a flowchart of the main steps executed as part of an exemplary process for performing a test framework (Selenium) ‘Driver findElement’, wherein the test is monitored by added or inserted test execution monitoring/control code/functionality, in accordance with some embodiments of the present invention.

Shown process steps include:

(1) Pre-Defense steps, for example, waiting for element presence; and (2) Exceptions Handling steps, taken in response to execution exceptions thrown, for example: (a) in response to a Timeout exception (e.g. in waiting for condition at the pre-defenses section/step)—increasing timeout; and/or (b) in response to a No Such Element exception—increasing timeout.

Thrown exceptions are handled and returned for retrying command execution. Upon a successful retry, or threshold number (e.g. 3) of failed retry/retries, the selenium Driver findElement is performed.

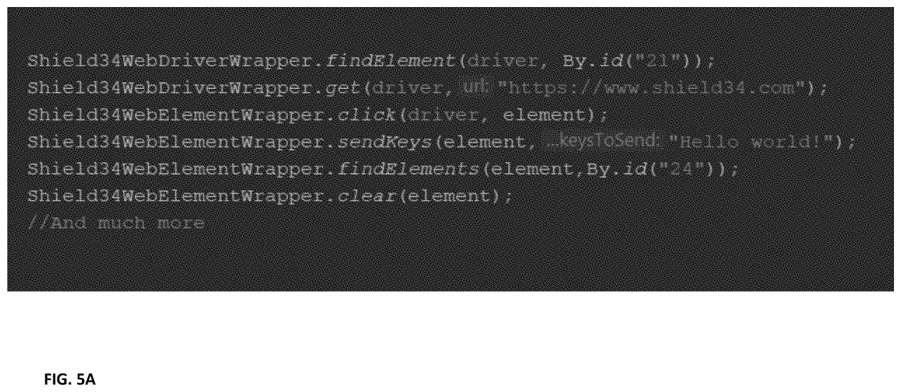

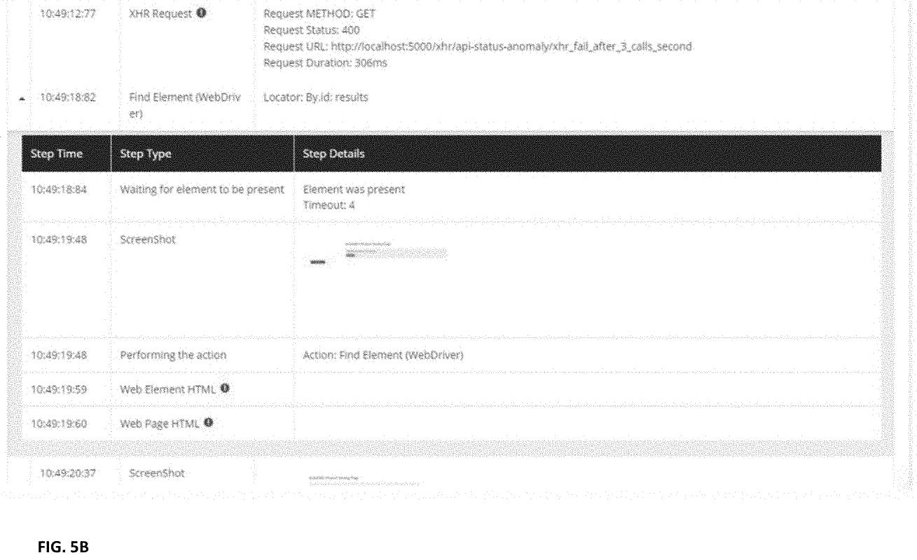

In FIGS. 5A-5C, there are shown test framework commands wrapping examples, and a demo of an exemplary wrapped commands test execution, along with reporting interface/dashboard screenshots associated therewith, in accordance with some embodiments of the present invention.

According to some embodiments, test framework (Selenium) commands may be wrapped, while being added a combination of the following layers: (1) Waiting for all required conditions to be fulfilled prior to executing the command; (2) Verifying the command was executed successfully; (3) Handling errors/exceptions thrown; and/or (4) Automatic retry in case of error, exception or verification failure. Test framework (Selenium) commands may not be substituted, eventually being executed, upon successful verification by the wrapping and monitoring code.

Reference is now made to FIG. 5A, where there are shown test framework commands wrapping examples, in accordance with some embodiments of the present invention.

According to some embodiments, an automatic report may be generated for each test-run. Various test-run actions may be collected and reported automatically by the system, for example: test-steps, screenshots, APIs (XHRs), page HTML, Cookies, local storage, CPU, memory, storage and more. Test-run reports may be based on command wrappings code execution as described herein and/or optionally by the addition of specific execution listeners and aggregating/cross-correlating data.

Reference is now made to FIG. 5B, where there is shown a screenshot of an exemplary reporting interface/dashboard presenting a wrapped commands test execution, in accordance with some embodiments of the present invention. For each execution step of a GET XHR Request—Step time, Step Type and Step Details are presented.

According to some embodiments, the system may receive user uploaded tests, for example zipped Selenium tests, replace framework (e.g. Selenium) commands with corresponding system wrapped commands and communicate the system handled code back to the user upon process completion or receipt of a download request.

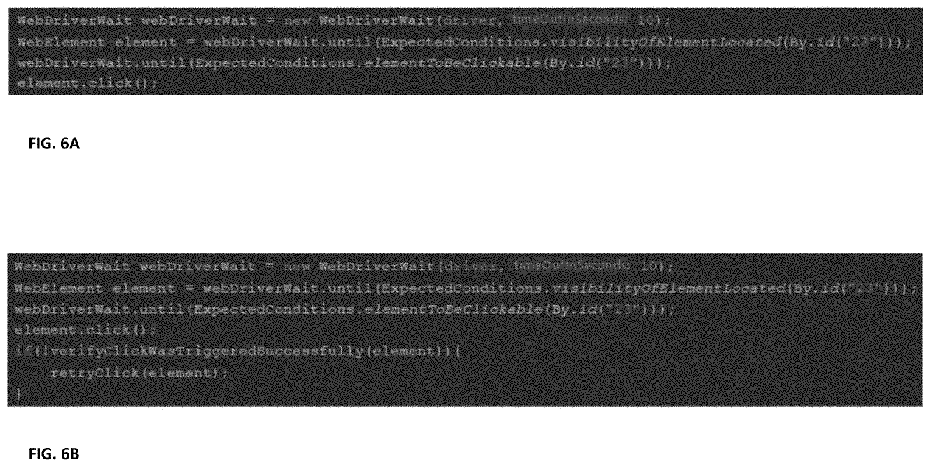

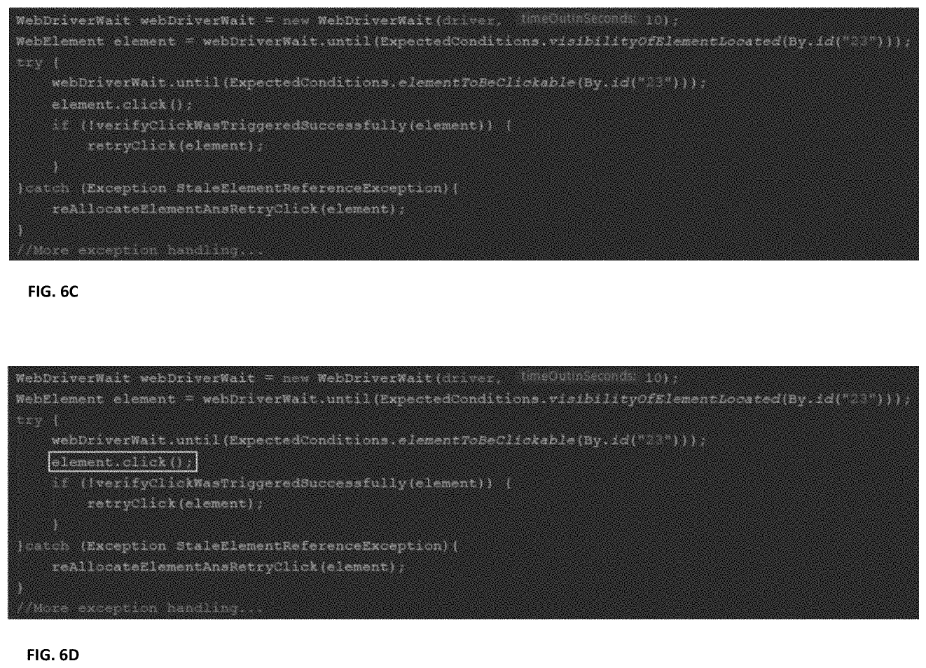

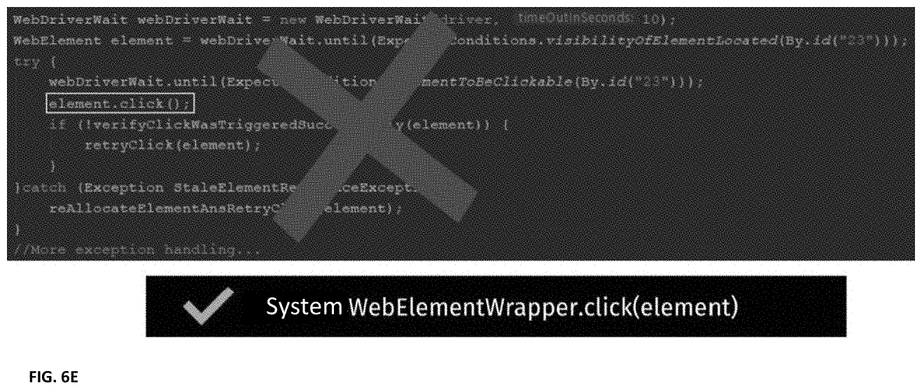

In FIGS. 6A-6E, there are shown, screenshots associated the main steps of an exemplary execution scenario of a test automation enhancement system implementing test-command monitoring-code insertion/wrapping, in accordance with some embodiments of the present invention.

Reference is now made to FIGS. 6A-6E, where monitoring/wrapping code is shown: awaiting for conditions fulfillment (6A); verifying successful actions execution (6B); and handling error/exception—executed code (6C), error/exception pinpointed (6D) and substitute system command forced due to error/exception (6E).

According to some embodiments of the present invention, a system for enhanced automated software code testing, may comprise a processing module for wrapping test script commands, of a software testing framework, with additional command execution monitoring or control code, wherein the command execution monitoring or control code, may be configured to collect and report test script execution parameters, resulting from test script execution; and a test execution monitoring module for guiding the execution of the test script commands based on the test script execution parameters reported by the command execution monitoring or control code.

According to some embodiments, guiding the execution of the test script commands may include waiting for a set of one or more required preconditions to be fulfilled, prior to executing a command.

According to some embodiments, guiding the execution of the test script commands may include detection of command execution exceptions.

According to some embodiments, the execution of a given command, for which one or more execution exceptions were detected, may be automatically retried.

According to some embodiments, the test execution monitoring module may be adapted to limit the number of retried executions of the given command, and upon reaching a threshold number of unsuccessful retried executions, generate: a feedback request, an execution failure notice, or a suggested test script change.

According to some embodiments, guiding the execution of the test script command may include verifying successful or complete execution of commands.

According to some embodiments, guiding the execution of the test script commands may include detection of command execution exceptions, wherein the unsuccessful or incomplete execution of a given command, for which no execution exceptions were detected, may be automatically retried.

According to some embodiments, the test execution monitoring module may be adapted to limit the number of retried executions of the given command, and upon reaching a threshold number of unsuccessful retried executions, generate: a feedback request, an execution failure notice, or a suggested test script change.

According to some embodiments, successful or complete execution of test script associated with creation of a screen element may be verified using a ‘click’ command of the element, wherein if a ‘click’ verification of the element fails on a first attempt, it may be automatically retried, at least a second time, at a different position on the element.

According to some embodiments, depending on the browser type of the tested code the element may be clicked, the second time—at its center for a first browser type or its left upper corner for a second browser type.

According to some embodiments, the processing module may be further adapted for queuing or ordering a test script command relative to other test script commands within the test script.

According to some embodiments, the processing module may be further adapted for queuing or ordering a test script command relative to detection of events occurring responsive to the execution of the test script.

According to some embodiments, the command execution monitoring or control code may be configured to collect one or more parameters, resulting from test script execution, which are associated with the appearance or creation of screen objects or elements.

According to some embodiments, the command execution monitoring or control code may be configured to collect one or more parameters, resulting from test script execution, which are associated with the notification of an execution exception.

According to some embodiments, the command execution monitoring or control code may be configured to collect one or more parameters, resulting from test script execution, which are associated with the computing resources usage or load, experienced as part of the test script execution.

According to some embodiments, collected computer resources parameters may be selected from the group consisting of: CPU load, memory usage, storage access rates and networking access rates.

According to some embodiments, the command execution monitoring or control code may be configured to collect one or more parameters, resulting from test script execution, which are associated with an API behavior.

According to some embodiments, the command execution monitoring or control code may be configured to collect one or more parameters, resulting from test script execution, and to report collected parameters indicative of the results of the execution monitoring, back to the test execution monitoring module, wherein the test execution monitoring module may be configured to generate review data from the reported monitoring data parameters, and to relay the review data for presentation over a system user interface dashboard rendered on a user device.

The subject matter described above is provided by way of illustration only and should not be constructed as limiting. While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A system for enhanced automated software code testing, said system comprising:
a processing module for wrapping test script commands, of a software testing framework, with additional command execution monitoring or control code;
said command execution monitoring or control code, configured to collect and report test script execution parameters, resulting from test script execution; and
a test execution monitoring module for guiding the execution of the test script commands based on the test script execution parameters reported by said command execution monitoring or control code.

2. The system according to claim 1, wherein guiding the execution of the test script commands includes waiting for a set of one or more required preconditions to be fulfilled, prior to executing a command.

3. The system according to claim 1, wherein guiding the execution of the test script commands includes detection of command execution exceptions.

4. The system according to claim 3, wherein the execution of a given command, for which one or more execution exceptions were detected, is automatically retried.

5. The system according to claim 4, wherein said test execution monitoring module is adapted to limit the number of retried executions of the given command, and upon reaching a threshold number of unsuccessful retried executions, generate: a feedback request, an execution failure notice, or a suggested test script change.

6. The system according to claim 1, wherein guiding the execution of the test script command includes verifying successful or complete execution of commands.

7. The system according to claim 6, wherein guiding the execution of the test script commands includes detection of command execution exceptions; and
wherein the unsuccessful or incomplete execution of a given command, for which no execution exceptions were detected, is automatically retried.

8. The system according to claim 7, wherein said test execution monitoring module is adapted to limit the number of retried executions of the given command, and upon reaching a threshold number of unsuccessful retried executions, generate: a feedback request, an execution failure notice, or a suggested test script change.

9. The system according to claim 6, wherein successful or complete execution of test script associated with creation of a screen element is verified using a ‘click’ command of the element; and
wherein if a ‘click’ verification of the element fails on a first attempt, it is automatically retried, at least a second time, at a different position on the element.

10. The system according to claim 9, wherein depending on the browser type of the tested code the element is clicked, the second time—at its center for a first browser type or its left upper corner for a second browser type.

11. The system according to claim 1, wherein said processing module is further adapted for queuing or ordering a test script command relative to other test script commands within the test script.

12. The system according to claim 1, wherein said processing module is further adapted for queuing or ordering a test script command relative to detection of events occurring responsive to the execution of the test script.

13. The system according to claim 1, wherein said command execution monitoring or control code is configured to collect one or more parameters, resulting from test script execution, which are associated with the appearance or creation of screen objects or elements.

14. The system according to claim 1, wherein said command execution monitoring or control code is configured to collect one or more parameters, resulting from test script execution, which are associated with the notification of an execution exception.

15. The system according to claim 1, wherein said command execution monitoring or control code is configured to collect one or more parameters, resulting from test script execution, which are associated with the computing resources usage or load, experienced as part of the test script execution.

16. The system according to claim 15, wherein collected computer resources parameters are selected from the group consisting of: CPU load, memory usage, storage access rates and networking access rates.

17. The system according to claim 1, wherein said command execution monitoring or control code is configured to collect one or more parameters, resulting from test script execution, which are associated with an API behavior.

18. The system according to claim 1, wherein said command execution monitoring or control code is configured to collect one or more parameters, resulting from test script execution, and to report collected parameters indicative of the results of the execution monitoring, back to said test execution monitoring module; and
wherein said test execution monitoring module is configured to generate review data from the reported monitoring data parameters, and to relay the review data for presentation over a system user interface dashboard rendered on a user device.
